(19) United States
(12) Patent Application Publication
(10) Pub. No.: US 2003/0207464 A1
(43) Pub. Date: Nov. 6, 2003

(54) Methods for microfluidic aspirating and dispensing

(76) Inventors: Tony Lemmo, Sudbury, MA (US); Don Rose, Chapel Hill, NC (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/443,699

(22) Filed: May 23, 2003

Related U.S. Application Data
(63) Continuation of application No. 09/253,123, filed on Feb. 19, 1999, now abandoned.

(51) Int. Cl. G01N 1/10; B01L 3/02

(52) U.S. Cl. 436/180; 422/100

(57) ABSTRACT

A method for actively controlling the hydraulic pressure within an aspirate-dispense system for aspirating and dispensing precise and/or predetermined quantities of fluid or reagent. The method provides an efficient pressure compensation scheme to achieve the optimal pressures for aspirating and dispensing. The optimized pressures are achieved by a series of operations of a positive displacement pump and a drop-on-demand valve of the aspirate-dispense system. Advantageously, the method increases process speed, improves reliability and accuracy, and reduces dilution and wastage of reagent.

### BACKGROUND OF THE INVENTION

1. Field of the Invention

The present invention relates generally to methods for aspirating and dispensing reagents and other liquids and, in particular, to various methods particularly adapted for optimally and efficiently aspirating and dispensing predetermined and/or precise microfluidic quantities of chemical/biological reagents.

2. Background of the Related Art

There is an ongoing effort, both public and private, to spell out the entire human genetic code by determining the structure of all 100,000 or so human genes. Also, simultaneously, there is a venture to use this genetic information for a wide variety of genomic applications. These include, for example, the creation of microarrays of DNA material on substrates to create an array of spots on microscope slides or biochip devices. These arrays can be used to read a particular human's genetic blueprint. The arrays decode the genetic differences that make one person chubbier, happier or more likely to get heart disease than another. Such arrays could detect mutations, or changes in an individual's chemical or genetic make-up, that might reveal something about a disease or a treatment strategy.

One typical way of forming DNA microarrays utilizes an aspirate-dispense methodology. An aspirate-dispense system aspirates (“sucks”) reagent(s) from a source of single strands of known DNA and dispenses (“spits”) them on one or more targets to form one or more DNA arrays. Typically, an unknown sample of DNA is broken into pieces and tagged with a fluorescent molecule. These pieces are poured onto the array(s); each piece binds only to its matching known DNA “zipper” on the array(s). The handling of the unknown DNA sample may also utilize an aspirate and/or dispense system. The perfect matches shine the brightest when the fluorescent DNA binds to them. Usually, a laser is used to scan the array(s) for bright, perfect matches and a computer ascertains or assembles the DNA sequence of the unknown sample.

Microfluidic aspirate-dispense technology also has a wide variety of other research and non-research related applications in the biodiagnostics, pharmaceutical, agrochemical and material sciences industries. Aspirate-dispense systems are utilized in drug discovery, high throughput screening, live cell dispensing, combinatorial chemistry and test strip fabrication among others. These systems may be used for compound reformatting, wherein compounds are transferred from one plate source, typically a 96 microwell plate, into another higher density plate such as a 384 or 1536 microwell plate. Compound reformatting entails aspirating sample from the source plate and dispensing into the target plate. In these and other applications it is desirable, and sometimes crucial, that the aspirate-dispense system operate efficiently, accurately and with minimal wastage of valuable reagents.

Conventional aspirate-dispense methods and technologies are well known in the art, for example, as disclosed in U.S. Pat. No. 5,741,554, incorporated herein by reference. These typically use pick-and-place (“suck-and-spit”) fluid handling systems, whereby a quantity of fluid is aspirated from a source and dispensed onto a target for testing or further processing. But to efficiently and accurately perform aspirate and dispense operations when dealing with microfluidic quantities, less than 1 microliter (μL), of fluid can be a very difficult task. The complexity of this task is further exacerbated when frequent transitions between aspirate and dispense functions are required. Many applications, such as DNA microarraying, can involve a large number of such transitions.

Conventional aspirate-dispense technology, when applied at these microfluidic levels, can suffer from unrepeatable and inconsistent performance and also result in wastage of valuable reagent. This is especially true at start-up and during transient or intermittent operations.

Therefore, there is a need for an improved methodology and technology that provides efficient, repeatable and accurate aspirate-dispense operations when handling and transferring fluids in microfluidic quantities, while minimizing wastage of such fluids.

### SUMMARY OF THE INVENTION

The present invention provides aspirating and dispensing methodology in accordance with one preferred method or embodiment which overcomes some or all of the above-mentioned disadvantages by actively controlling the hydraulic pressure in the aspirate-dispense system. Preferably, this active control utilizes a series of operations that adjust a positive displacement pump and/or a drop-on-demand valve of the aspirate-dispense system or apparatus. Advantageously, these operations provide repeatable, accurate and efficient performance, and minimize wastage and dilution of reagent.

The present invention recognizes the presence and importance of a steady state and/or predetermined pressure in a positive-displacement aspirate-dispense system. One preferred method of the present invention facilitates the aspirate-dispense process by providing an efficient pressure compensation scheme which is efficient in both fluid consumption and time. The aspirate-dispense system generally includes a positive-displacement syringe pump and a drop-on-demand valve, such as a solenoid-actuated valve, hydraulically coupled to a tip and a nozzle or “aspirating tube.” The syringe pump is filled with a system fluid, such as distilled water, or a reagent and is also in communication with a reservoir containing the same.

In accordance with one preferred embodiment, the present invention provides a method for aspirating a fluid from a source using an aspirate-dispense system which includes a drop-on-demand valve in fluid communication with a direct current fluid source. The method includes the step of reducing the hydraulic pressure within the system by opening the drop-on-demand valve to dispense system liquid into a non-target position. An aspirating tube or nozzle of the aspirate-dispense system is then dipped into the fluid source. A reduced pressure is created within the system to aspirate a quantity of fluid from the fluid source into the tube or tip of the aspirate-dispense system.

In accordance with another preferred embodiment, the present invention provides a method for aspirating a fluid from a source. The method includes the step of reducing the hydraulic pressure within an aspirate-dispense system by withdrawing a predetermined quantity of system fluid from a feedline of the system. An aspirating tube or nozzle of the aspirate-dispense system is then dipped into the fluid source. The positive displacement means of the system are adjusted so that a reduced pressure is created in the system to aspirate a quantity of the fluid from the source into the tube or tip of the system.

In accordance with another preferred embodiment, the present invention provides a method for dispensing a fluid onto a target using an aspirate-dispense system which includes a drop-on-demand valve in fluid communication with a direct current fluid source. The method includes the step of pressurizing the system by adjusting the direct current fluid source while maintaining the valve of the system in a closed position to build hydraulic pressure within the system to a generally steady state and/or predetermined value. A desired flow rate is then selected for dispensing the fluid from a tube or tip/nozzle of the system onto the target. The direct current fluid source and the valve are operated to dispense precise and/or predetermined quantities of the fluid onto the target.

In accordance with another preferred embodiment, the present invention provides a method for aspirating fluid from a source and dispensing the fluid onto a target using an aspirate-dispense system which includes a drop-on-demand valve in hydraulic communication with a direct current fluid source. The method includes the step of adjusting the system by opening the valve to dispense system liquid into a non-target position so that the hydraulic pressure within the system is reduced. A tube or nozzle of the aspirate-dispense system is then dipped into the fluid source. A reduced pressure is created within the system by operating the direct current fluid source to aspirate a quantity of fluid from the fluid source into the tube or tip of the aspirate-dispense system. The system is pressurized by adjusting the direct current fluid source while the valve is maintained in a closed position to build hydraulic pressure within the system to a generally steady state value. The direct current fluid source and the valve of the system are actuated to dispense precise and/or predetermined quantities of the fluid onto the target.

In accordance with another preferred embodiment of the present invention an apparatus is provided for aspirating and/or dispensing predetermined quantities of a fluid. The apparatus generally comprises a dispenser, a direct current fluid source and one or more pressure sensors. The dispenser includes a drop-on-demand valve adapted to be opened and closed at a predetermined frequency and/or duty cycle. The direct current fluid source is in fluid communication with the dispenser for metering predetermined quantities of the fluid to or from the dispenser. The one or more pressure sensors are placed intermediate the dispenser and the direct current fluid source and/or at the dispenser for monitoring the hydraulic pressure within the apparatus. Accordingly, the actuations of the valve and/or the direct current fluid source provide pressure compensation prior to aspirate and/or dispense functions by reducing or raising the hydraulic pressure within the apparatus to a predetermined and/or-generally steady state pressure.

In accordance with another preferred embodiment of the present invention a hydraulic system is provided for dispensing precise quantities of a fluid. The hydraulic system generally comprises a dispenser and a direct current fluid source. The dispenser includes a drop-on-demand valve adapted to be opened and closed at a predetermined frequency and/or duty cycle. The direct current fluid source is in fluid communication with the dispenser for metering predetermined quantities of the fluid to the dispenser. The output fluid flow rate (Qₙ) of the hydraulic system may be characterized by a transfer function having the general form:

$$\frac{{Q}_{n}}{{Q}_{t}} = \frac{\frac{K}{s ( s + \frac{1}{τ} )}}{1 + \frac{K}{s ( s + \frac{1}{τ} )}} = \frac{1}{1 + \frac{1}{K} s ( s + \frac{1}{τ} )}$$

with a characteristic equation given by:

$$1 + \frac{K}{s ( s + \frac{1}{τ} )} = 0$$

and a gain K given by:

$$K = \frac{1}{{R}_{t} C τ}$$

where, Qₜ is the input fluid flow rate provided by the direct current fluid source, Rₜ is the flow resistance, C is the elastic capacitance, τ is the inertial or inductive time constant, and s is the Laplacian variable.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is a simplified schematic illustration of a microfluidic aspirate-dispense system/apparatus for aspirating and dispensing precise quantities of liquid;

FIG. 2 is a cross-sectional detail view of the syringe pump of FIG. 1;

FIG. 3 is a schematic illustration of a solenoid valve dispenser for use in the system of FIG. 1;

FIG. 4 is a simplified fluid circuit schematic of the system of FIG. 1;

FIG. 5 is a simplified electrical circuit analogue representation of the system of FIG. 1;

FIG. 6A is a control block diagram representation of the system of FIG. 1;

FIG. 6B is a simplified version of the control block diagram of FIG. 6A;

FIG. 6C is a root-locus diagram of the system of FIG. 1;

FIG. 7A is a schematic graph (not to scale) of system pressure versus time illustrating a non-optimized aspirate-dispense cycle;

FIG. 7B is a schematic graph (not to scale) of system pressure versus time illustrating an aspirate-dispense cycle in accordance with one preferred method of the present invention;

FIG. 8 is a graph illustrating non-steady state dispense volumes versus steady state dispense volumes and showing the beneficial effects of the pressure compensation scheme of the method of the present invention;

FIG. 9 is a schematic illustration of a bullet-shaped fluid velocity profile during aspirate and dispense functions in accordance with one preferred method of the present invention;

FIG. 10 is a schematic illustration of a blunt fluid velocity profile in accordance with another preferred method of the present invention; and

FIG. 11 is a schematic illustration of a system for removing excess fluid from the nozzle/tip of the dispenser of FIG. 3.

### DETAILED DESCRIPTION OF THE PREFERRED EMBODIMENTS

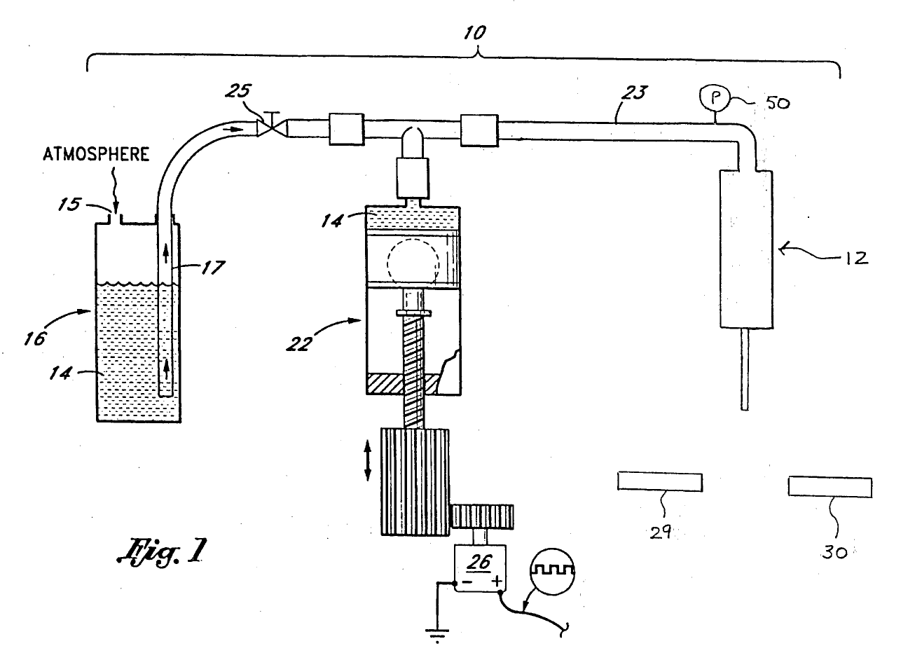

FIG. 1 is a schematic drawing of a microfluidic aspirate-dispense apparatus or system 10 having features in accordance with one preferred embodiment of the present invention. The aspirate-dispense system 10 generally comprises a dispenser 12 and a positive displacement syringe pump 22 intermediate a reservoir 16. The dispenser 12 is used to aspirate a predetermined quantity of fluid or reagent from a source or receptacle 29 and dispense a predetermined quantity, in the form of droplets or a spray pattern, of the source fluid onto or into a target 30. The positive displacement pump 22 meters the volume and/or flow rate of the reagent aspirated and, more critically, of the reagent dispensed. The reservoir 16 contains a wash or system fluid 14, such as distilled water, which fills most of the aspirate-dispense system 10. A robot arm may be used to maneuver the aspirate-dispense system 10 or alternatively the aspirate-dispense system 10 and/or its associated components may be mounted on movable X, X-Y or X-Y-Z platforms. In some situations, where large quantities of the same reagent are to be dispensed, the reservoir 16 and syringe pump 22 can be filled with the reagent and the system 10 can be used purely for dispensing. Also, multiple aspirate-dispense systems 10 may be utilized to form a line or array of dispensers 12.

The pump 22 is preferably a high-resolution, positive displacement syringe pump hydraulically coupled to the dispenser 12. Alternatively, pump 22 may be any one of several varieties of commercially available pumping devices for metering precise quantities of liquid. A syringe-type pump 22, as shown in FIG. 1, is preferred because of its convenience and commercial availability. A wide variety of other direct current fluid source means may be used, however, to achieve the benefits and advantages as disclosed herein. These may include, without limitation, rotary pumps, peristaltic pumps, squash-plate pumps, and the like, or an electronically regulated fluid current source.

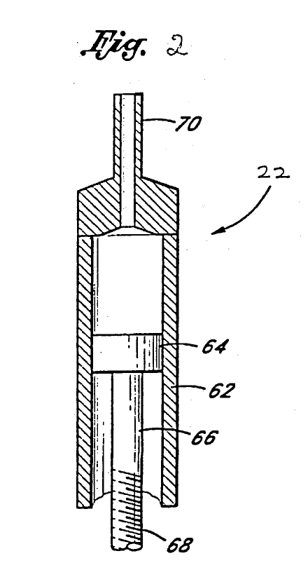

As illustrated in more detail in FIG. 2, the syringe pump 22 generally comprises a syringe housing 62 of a predetermined volume and a plunger 64 which is sealed against the syringe housing by O-rings or the like. The plunger 64 mechanically engages a plunger shaft 66 having a lead screw portion 68 adapted to thread in and out of a base support (not shown). Those skilled in the art will readily appreciate that as the lead screw portion 68 of the plunger shaft 66 is rotated the plunger 64 will be displaced axially, forcing system fluid from the syringe housing 62 into the exit tube 70. Any number of suitable motors or mechanical actuators may be used to drive the lead screw 68. Preferably, a stepper motor 26 (FIG. 1) or other incremental or continuous actuator device is used so that the amount and/or flow rate of fluid or reagent can be precisely regulated.

Referring to FIG. 1, the syringe pump 22 is connected to the reservoir 16 and the dispenser 12 using tubing 23 provided with luer-type fittings for connection to the syringe and dispenser. Various shut-off valves 25 and check valves (not shown) may also be used, as desired or needed, to direct the flow of fluid 14 to and/or from the reservoir 16, syringe pump 22 and dispenser 12.

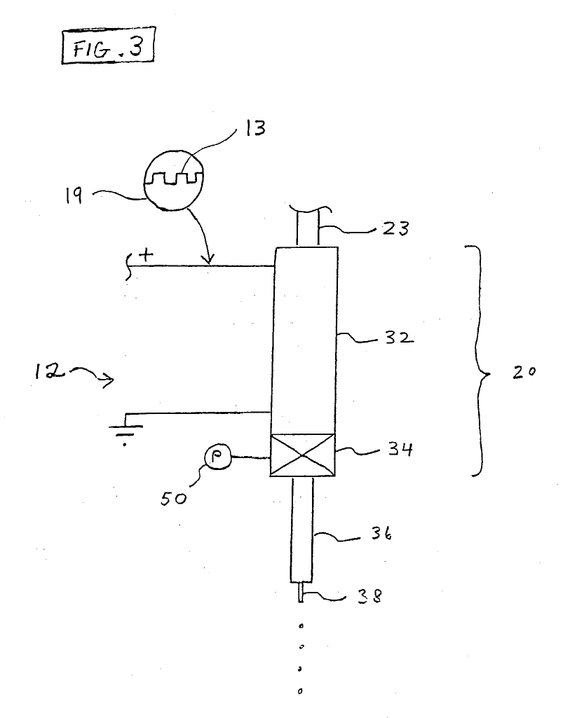

The dispenser 12 (FIG. 1) may be any one of a number of dispensers well known in the art for dispensing a liquid, such as a solenoid valve dispenser, a piezoelectric dispenser, a fluid impulse dispenser, a heat actuated dispenser or the like. In one form of the present invention a solenoid dispenser 12, schematically illustrated in FIG. 3, is preferred. Referring to FIG. 3, the solenoid valve dispenser 12 generally comprises a solenoid-actuated drop-on-demand valve 20, including a valve portion 34 and a solenoid actuator 32, hydraulically coupled to a tube or tip 36 and nozzle 38. The solenoid valve 20 is energized by one or more electrical pulses 13 provided by a pulse generator 19. A detailed description of one typical solenoid valve dispenser can be found in U.S. Pat. No. 5,741,554, incorporated herein by reference.

Referring to FIG. 1, the wash fluid reservoir 16 may be any one of a number of suitable receptacles capable of allowing the wash fluid 14, such as distilled water, to be siphoned into pump 22. The reservoir may be pressurized, as desired, but is preferably vented to the atmosphere, as shown, via a vent opening 15. The particular size and shape of the reservoir 16 is relatively unimportant. A siphon tube 17 extends downward into the reservoir 16 to a desired depth sufficient to allow siphoning of wash fluid 14. Preferably, the siphon tube 17 extends as deep as possible into the reservoir 16 without causing blockage of the lower inlet portion of the tube 17. Optionally, the lower inlet portion of the tube 17 may be cut at an angle or have other features as necessary or desirable to provide consistent and reliable siphoning of wash fluid 14.

Those skilled in the art will recognize that the hydraulic coupling between the pump 22 and the dispenser 12 provides for the situation where the input from the pump 22 exactly equals the output from the dispenser 12 under steady state conditions. Therefore, the positive displacement system uniquely determines the output volume of the system while the operational dynamics of the dispenser 12 serve to transform the output volume into ejected drop(s) having size, frequency and velocity.

It has been discovered, however, that within the aspirate-dispense system 10 there exists an elastic compliance partly due to the compliance in the delivery tubing and other connectors and components, and partly due to gaseous air bubbles that may have precipitated from air or other gases dissolved in the system and/or source fluid. As a result of this elastic compliance, initial efforts to dispense small quantities of fluid resulted in gradually overcoming the system compliance and not in dispensing fluid or reagent. Once this elastic compliance was overcome, a steady state pressure was found to exist and complete dispensing occurred thereafter. To understand this phenomenon and the features and advantages of the present invention, it is helpful to first discuss the theoretical predicted behavior and theoretical flow models relating to the positive displacement dispensing and aspirating system 10 of FIG. 1.

Theory of Operation for Positive Displacement Dispensing/Aspirating

The models included herein depict the basic theory of operation of the positive displacement dispense/aspirate system of FIG. 1. Of course, the models may also apply to other direct current fluid source dispensing devices for dispensing small quantities of fluid. These models examine the design and operation of the dispensing system from a mathematical, physical, circuit and block diagram perspective representation, with each perspective being equivalent but offering a distinct view of the system.

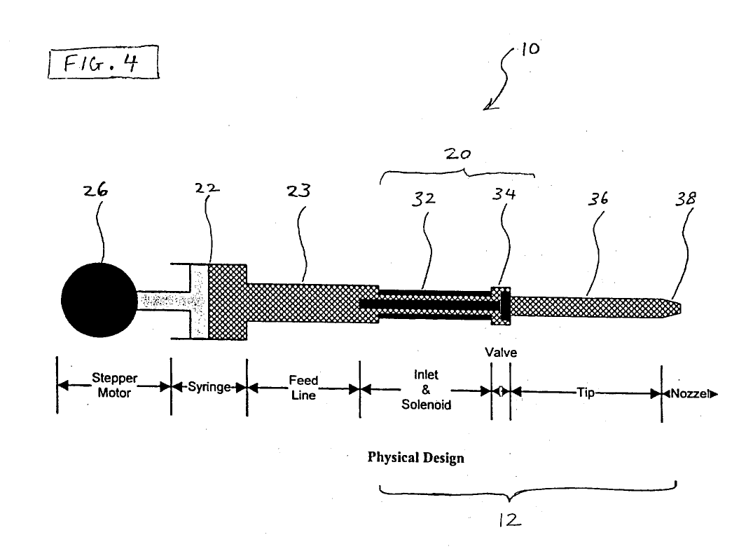

FIG. 4 is a simplified fluid circuit schematic drawing of the aspirate-dispense system or apparatus 10 of FIG. 1. The dispense system 10 generally comprises a dispenser 12 and a positive displacement syringe pump 22 driven by a stepper motor 26. The syringe pump 22 is hydraulically coupled to the dispenser 12 via a feedline 23. The dispenser 12 includes a drop-on-demand valve 20, such as a solenoid-actuated valve with a solenoid actuator 32 and a valve portion 34. The valve 20 is coupled to a tube or tip 36 and a drop-forming nozzle 38. The positive displacement pump 22 meters the volume and/or flow rate of the reagent or fluid dispensed. The dispenser 12 is selectively operated to provide individual droplets or a spray pattern of reagent, as desired, at the predetermined incremental quantity or metered flow rate. The dispenser 12 may also be operated in an aspirate mode to “suck” reagent or other liquids from a fluid source.

As noted above, the positive displacement pump 22 is placed in series with the dispenser 12 (FIGS. 1 and 4) and has the benefit of forcing the dispenser 12 to admit and eject a quantity and/or flow rate of reagent as determined (under steady state conditions) solely by the positive displacement pump 22. In essence, the syringe pump 22 acts as a forcing function for the entire system, ensuring that the desired flow rate is maintained regardless of the duty cycle, frequency or other operating parameters of the dispensing valve, such as the solenoid-actuated valve 20. This is certainly true for steady state operation, as discussed in more detail below. However, for non-steady state operation, it has been discovered that the elastic capacitance of the feedline and precipitated gaseous bubbles in the system can cause transient changes in dispensing pressure and system behavior.

A major part of the hydraulic compressibility or compliance within the system 10 (FIGS. 1 and 4) is due to precipitated air. The nominal solubility of air in liquids is in the range of about 2%. Even a small amount of this air converted to bubbles within the hydraulic system will dominate the compliance of the system 10. Thus, the dissolved air represents an important variable in determining the compliance or elastic capacitance, C, and hence determining the actuations of the drop-on-demand valve 20 (FIGS. 3 and 4) and syringe pump 22 (FIGS. 1 and 4) to bring the system to the desired predetermined and/or steady state pressure conditions (as discussed in greater detail herein below). The reagents used with the method of the present invention can be degassed, by using known surfactants. This reduces the influence of precipitated air in the system, and hence simplifies valve and pump actuations, and improved repeatability of the actuations to achieve the desired pressure conditions.

The aspirate-dispense apparatus 10 (FIG. 1) can also be configured to minimize the formation and accumulation of gaseous bubbles within the fluid residing in the system 10 and particularly in the feedline 23 and dispenser 12. For example, to minimize bubble formation, the components of the aspirate-dispense system 10 can be configured so that the fluid movements within the system avoid sharp local pressure drops, and hence gaseous bubble precipitation. Additionally, the components may be configured such that none or few “dead spots” are encountered by the fluid, thereby discouraging bubble accumulation within the system. Optionally, bubble removal means, such as a suitably configured bubble trap, may be used. Nevertheless, despite whatever measures are taken, there will be at least some elastic compliance in the system which can cause transient variations in performance. These are discussed in more detail below.

In fluid flow analysis, it is typical to represent the fluid circuit in terms of an equivalent electrical circuit because the visualization of the solution to the various flow and pressure equations is more apparent. The electrical circuit components used in this analysis include flow resistance (R), elastic capacitance (C) and inertial inductance (L). As is known in the art, the electrical equivalent of hydraulic pressure, P, is voltage and the electrical equivalent of flow or flow rate, Q, is current. The following defines the basic mathematical characteristics of the components.

Resistance

Flow resistance, R, is modeled as a resistor in the equivalent circuit and can be mathematically represented by the following:

$$\frac{\partial P}{\partial Q} = R \qquad ( 1 )$$

In the case of fluid flow, the resistance is usually nonlinear because of orifice constrictions which give rise to quadratic flow equations. This is further elaborated below. In the present analysis it is assumed that laminar flow conditions are present and that fluid flows through a circular cross section. There are two types of flow resistance: capillary and orifice. Capillary flow resistance applies to flow through sections of tubes and pipes. Orifice flow resistance applies to constrictions or changes in flow direction. Capillary resistance can be represented by the following:

Q=A\overline{u} (2)

$$\begin{matrix}{R}_{c} = \frac{Ω {L}_{c}}{{A}_{c}} & ( 3 ) \\ Ω = \frac{8 μ}{{r}_{c}^{2}} & ( 4 )\end{matrix}$$

where, R_{c} is the capillary flow resistance, Q is the flow rate, A_{c} is the cross-sectional area, \overline{u} is the mean velocity of flow, Ω is the flow resistivity, L_{c} is the capillary length, μ is the viscosity, and r_{c} is the radius of the circular capillary.

Orifice resistance is represented as:

$$\begin{matrix}Q = \frac{\sqrt{Δ P}}{{R}_{o}} & ( 5 ) \\ {R}_{o} = \frac{\sqrt{\frac{ρ}{2}}}{{A}_{o} {C}_{d}} & ( 6 )\end{matrix}$$

where, Rₒ is the orifice flow resistance, ρ is the fluid density, Aₒ is the cross-sectional area, and C_{d} is the discharge coefficient.

For a nozzle, the orifice constriction occurs at the entrance to the nozzle and the nozzle is a capillary (straight tube). This results in two resistances, orifice and capillary, in series. In general, the pressure and flow relationships in a system composed of a number of orifices and capillaries can be defined under these conditions as:

$$Δ P = Σ {R}_{o}^{2} {Q}^{2} + Σ {R}_{c} Q \qquad ( 7 )$$

where ΔP is the pressure drop, the quadratic term Rₒ²Q² is due to the orifice resistance, which depends on the fluid density, and the linear term R_{c}Q is due to the capillary resistance, which depends on the fluid viscosity. This suggests that for a given geometry it may be possible to measure these fluid properties (density and viscosity) by performing regression fits to pressure and flow data. In order to model the resistance, all the orifices and capillaries of the system need to be identified.

Inductance

In laminar fluid flow through capillaries, the fluid velocity profile is parabolic with zero velocity at the capillary wall and the maximum velocity at the center. The mean velocity \overline{u} is one half the maximum velocity. Since the fluid has mass and inertia, there is a time constant associated with the buildup of flow in the tube. This is modeled as an inductance in series with the resistance. The derivation of the inertial time constant, τ, is illustrated in Modeling Axisymmetric Flows, S. Middleman, Academic Press, 1995, Page 99, incorporated herein by reference. The time constant, τ, can be defined as:

$$τ = \frac{L}{{R}_{c}} = \frac{ρ {r}_{c}^{2}}{μ {a}_{1}^{2}} \qquad ( 8 )$$

where L is the inductance and a₁=2.403. Thus, the inertial inductance can easily be computed from the time constant, τ, and the capillary flow resistance, R_{c}.

Capacitance

The walls of the feedline, any precipitated gaseous bubbles in the fluid, and (to a very limited extent) the fluid itself, are all elastic (compressible). This phenomenon gives rise to an elastic capacitance, where energy can be stored by virtue of the compression of the fluid and bubbles and/or the expansion of the feedline walls. The magnitude of the capacitance, C, can be found from the following equations:

Zₐ=ρCₛ (9)

$$\begin{matrix}{Z}_{ratio} = \frac{{Z}_{a}}{Ω L} & ( 10 ) \\ C = \frac{L}{{( {Z}_{ratio} {R}_{c} )}^{2}} & ( 11 )\end{matrix}$$

where, Zₐ is the acoustic impedance and Cₛ is the speed of sound. The speed of sound, Cₛ, accounts for the effects of fluid bulk modulus, wall elasticity, and elastic effects of any gas in the system. In the present modeling, the feedline is the major contributor to the elastic capacitance.

Physical Fluid Circuit Representation

The overall fluid circuit schematic construction of the dispense system 10 (FIG. 1) is shown in FIG. 4. As discussed above, the system 10 generally includes a stepper motor 26, a syringe pump 22, a feedline 23, and a drop-on-demand valve 20, with a solenoid actuator 32 and a valve portion 34, coupled to a tip 36 and a nozzle 38.

The syringe pump 22 (FIGS. 1 and 4) of the system acts as a fluid current source and forces a given volume per step into the system. The force available from the stepper motor 26 (FIGS. 1 and 4) is essentially infinite, due to the large gear ratio to the syringe input. The input is impeded from the forces feeding back from the system. Since volume, V, is the integral of the flow rate:

V=∫Qdt (12)

and the flow rate, Q, is modeled as current, the syringe pump is therefore a current source rather than a pressure (voltage) source. Since any impedance in series with a current source has no effect on the flow rate, this has the beneficial effect of removing the influence of the impedance of the feed line (resistance and inductance) on the flow rate. Advantageously, this solves a major problem that would be present if a pressure source were used as the driving function. For a pressure source, the feedline impedance would offer a changing and/or unpredictable resistance to flow and could give rise to hydraulic hammer pressure pulses and varying pressure drops across the feedline which could affect the flow rate through the dispense system, and hence the fluid output. By utilizing a current source, such as the syringe pump, the effect of changes in fluid impedance is substantially negligible or none on the flow rate, and thus accurate fluid volumes can be readily dispensed.

Electrical Circuit Analogue Representation

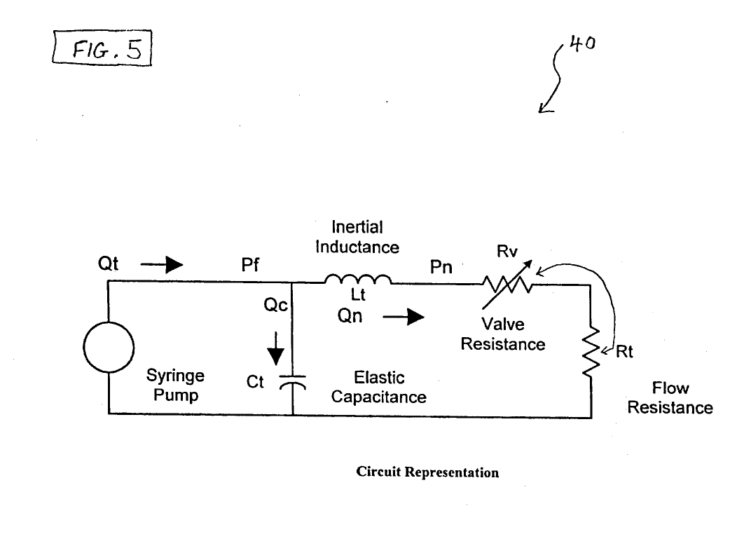

A simplified circuit analogue representation 40 of the dispense system 10 (FIG. 1) is shown in FIG. 5. The syringe pump 22 forces a total flow rate of Qₜ into the system. The flow is comprised of Q_{c} and Qₙ. Q_{c} is the flow that is driven into the elastic capacitance Cₜ of the system and Qₙ is the flow rate that is output from the nozzle 38 of the system. The inductance Lₜ and resistance Rₜ are the totals of all elements within the valve 20, tip 36, nozzle 38 and feedline 23. The valve resistance Rᵥ varies with the actuation displacement of the valve 20 during operation from forces applied by the solenoid actuator 32. When the valve 20 is closed, the valve resistance Rᵥ is infinite. The pressure in the feedline 23 is P_{f} and the pressure at the nozzle 38 is Pₙ.

Block Diagram Representation

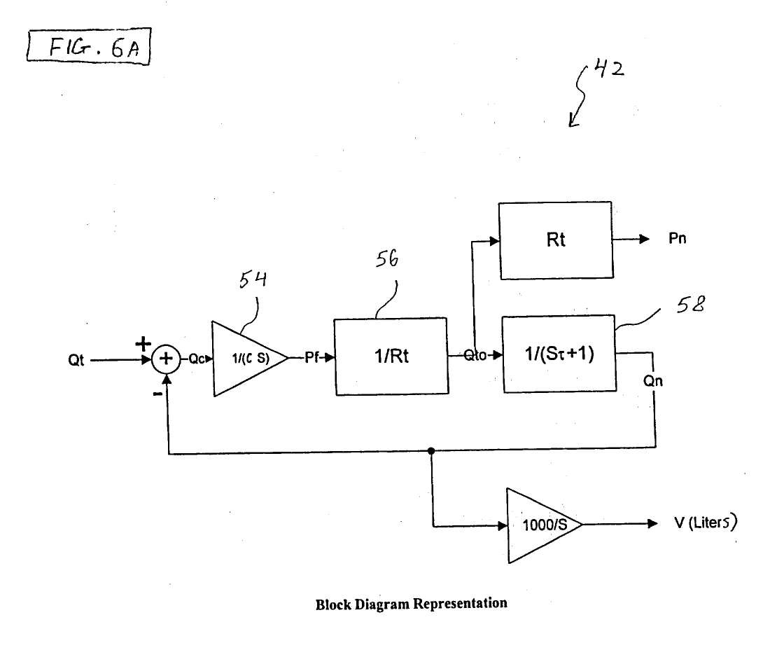

A block diagram or control system representation 42 of the dispense system 10 (FIG. 1) is shown in FIG. 6A. This is perhaps the best way to see why the output fluid volume is synchronized to the syringe input. As can be seen from FIG. 6A, this block diagram model 42 represents a feedback loop, in which the difference between Qₜ and Qₙ drives the flow into the elastic capacitance, Q_{c}. If the flow out of the nozzle 38 is not exactly the same as the flow input, Qₜ, then the pressure in the feedline 23, P_{f}, will change. The feedback loop forces the value of P_{f} to be whatever is necessary, at steady state, to maintain the output flow rate, Qₙ, to equal the input flow rate, Qₜ. This is true regardless of the value of Rₜ. The inductive time constant is τ (in FIG. 6A) and the Laplacian Operator is s=jω.

The value of feedline pressure, P_{f}, will increase when the valve 20 (FIGS. 3 and 4) is closed (Qn=0), since all the input flow will go into the elastic capacitance as Q_{c}. The use of a time constant in the block diagram 42 (FIG. 6A) simplifies the mathematical calculations when the valve has infinite resistance. Qualitatively similar results will be obtained if the block diagram 42 (FIG. 6A) is modeled in a form including the unreduced Laplacian formula for inductance (L) instead of the simplified time constant (τ).

The block diagram model 42 (FIG. 6A) indicates that the system has the potential for damped oscillations in flow. The elastic capacitance is an integrator and the inertial time constant, τ, in the loop can give rise to the possibility of underdamped oscillations in transient flow. These oscillations may show up in pressure readings in the feedline 23 (FIGS. 1 and 4). The magnitude of the oscillations is dependent on the damping, which, in turn, is dependent on the flow resistance and the resonate frequency of the system.

The closed-loop transfer function of the control system 42 (FIG. 6A) may be generally stated as follows:

$$W ( s ) = \frac{G ( s )}{1 + G ( s ) H ( s )} \qquad ( 13 )$$

where:

W(s)=transfer function of the system expressed in the Laplace domain;

G(s)=forward transfer function; and

H(s)=feedback transfer function.

The forward transfer function G through blocks or control elements 54, 56, 58 (FIG. 6A) may be expressed as follows:

$$G ( s ) = \frac{1}{{C}_{S}} \frac{1}{{R}_{t}} \frac{1}{s τ + 1} = ( \frac{1}{{R}_{t} C τ} ) \frac{1}{s ( s + \frac{1}{τ} )} \qquad ( 14 )$$

By using equation (14), the control block diagram 42 (FIG. 6A) can also be represented by a simplified equivalent block diagram 60 (FIG. 6B) with a block element 61 (FIG. 6B). The control or block element 61 (FIG. 6B) incorporates the reduced forward transfer function of equation (14). The feedback transfer function H for the block diagram 42 (FIG. 6A) may be expressed as follows:

H(s)=1 (15)

Substituting equations (14) and (15) in equation (13), the unreduced closed-loop transfer function is expressed as:

$$W ( s ) = \frac{G ( s )}{1 + G ( s ) H ( s )} = \frac{{Q}_{n}}{{Q}_{t}} = \frac{( \frac{1}{{R}_{t} C τ} ) \frac{1}{s ( s + \frac{1}{τ} )}}{1 + ( \frac{1}{{R}_{t} C τ} ) \frac{1}{s ( s + \frac{1}{τ} )}} \qquad ( 16 )$$

Equation (16) can be simplified to yield the closed-loop transfer function in a reduced form, as shown below by equation (17):

$$W ( s ) = \frac{{Q}_{n}}{{Q}_{t}} = \frac{1}{1 + ( {R}_{t} C τ ) s ( s + \frac{1}{τ} )} \qquad ( 17 )$$

The characteristic equation of the control system is defined by setting the denominator of equation (16) equal to zero and is given by:

$$1 + ( \frac{1}{{R}_{t} C τ} ) \frac{1}{s ( s + \frac{1}{τ} )} = 0 \qquad ( 18 )$$

The zeros and poles of the characteristic equation can be determined by the expression:

$$K \frac{Z ( s )}{P ( s )} = G ( s ) H ( s ) = ( \frac{1}{{R}_{t} C τ} ) \frac{1}{s ( s + \frac{1}{τ} )} \qquad ( 19 )$$

where, K is the gain and Z(s) and P(s) are polynomials which yield the zeros and poles. The above characteristic equation (18) has no zeros (n_{z}=0) and two poles (nₚ=2) P₁=0 and P₂=−1/τ, where n_{z} is the number of zeros and nₚ is the number of poles. Also, the gain K of the system can be defined as:

$$K = \frac{1}{{R}_{t} C τ} \qquad ( 20 )$$

The characteristic equation (18) can be manipulated to give a quadratic equation (21):

$${s}^{2} + ( \frac{1}{τ} ) s + K = O \qquad ( 21 )$$

where K is the gain as defined above by the expression (20). Since equation (20) is a quadratic equation it has two roots which can be expressed as:

$${s}_{r} = - \frac{1}{2 τ} [ 1 \pm \sqrt{1 - 4 {τ}^{2} K} ] \qquad ( 22 )$$

These roots sᵣ determine the stability characteristics of the control system 42 (FIG. 6A). The nature of the roots sᵣ is dependent on the magnitude of the gain K=1/(RₜCτ), or more specifically on the magnitude of the parameter (4τ²K=4τ/RₜC). Note that since the time constant (τ), the resistance (Rₜ), and the capacitance (C) are all positive real numbers, the parameter (4τ²K) is also a positive real number. The only exception to this is when the valve 20 (FIGS. 3 and 4) is closed, and hence the resistance Rₜ is infinite which results in K=0, so that (4τ²K)=0.

For the case of 0<(4τ²K)≦1, it is easily deduced that the characteristic equation (18) or (21) has two real roots sᵣ<0. This indicates that the control system 42 (FIG. 6A) is unconditionally stable for 0<(4τ²K)≦1.

For the case of (4τ²K)>1, it is easily deduced that the characteristic equation (18) or (21) has two real complex conjugate roots sᵣ which have negative real parts. This indicates that the control system 42 (FIG. 6A) is unconditionally stable for (4τ²K)>1.

For the case of (4τ/RₜC)=0, that is when the valve 20 (FIGS. 3 and 4) is closed and the resistance Rₜ→infinity (K=0), it is easily deduced that the characteristic equation (18) or (21) has two real roots sᵣ=0 and sᵣ<0. This indicates that the control system 42 (FIG. 6A) is limitedly stable for (4τ²K)=0 or K=0.

The above stability analysis shows that the control block representation 42 (FIG. 6A) of the positive displacement aspirate-dispense system 10 (FIG. 1) is always stable. This is true as the parameter (4τ²K), or alternatively the gain K, is varied from zero to infinity.

Another popular technique for studying the stability characteristics of a control system involves sketching a root locus diagram of the roots of the characteristic equation as any single parameter, such as the gain K, is varied from zero to infinity. A discussion of the root locus method can be found in most control theory texts, for example, Introduction to Control System Analysis and Design, Hale, F. J., Prentice-Hall, Inc., 1973, Pages 137-164, incorporated herein by reference.

FIG. 6C shows a sketch of a root locus diagram 72 for the control system representation 42 (FIG. 6A). The root locus diagram 72 is plotted in the s-plane and includes a real axis 74, Re(s), an imaginary axis 76, Im(s), and a sketch of the root locus 78.

Typically, the determination of the root locus relies on a knowledge of the zeros and poles of the control system. As indicated above, the characteristic equation (18) of the control block diagram 42 (FIG. 6A) has no zeros (n_{z}=0) and two poles (nₚ=2). Thus, the root locus 78 (FIG. 6C) will have two branches and two zeros at infinity. On the real axis 74 (FIG. 6C), the root locus will exist only between the two poles P₁=0 and P₂=−1/τ. Since there are two infinite zeros, there will be two asymptotes to the locus branches at angles given by:

$${θ}_{k} = \frac{( 2 k + 1 ) 180 °}{{n}_{p} - {n}_{z}} k = 0 , 1 \qquad ( 23 )$$

so that, θₖ=90°, 270°. The cg or intersection of the asymptotes and the real axis 74 (FIG. 6C) is given by:

$$cg = \frac{{\sum }^{} poles - \sum zeros}{{n}_{p} - {n}_{z}} \qquad ( 24 )$$

so that, cg=−½τ. Since there are only two poles P₁ and P₂ on the real axis the breakaway point between the two poles, P₁=0 and P₂=−1/τ, is halfway between the poles, that is, at s=−½τ. Also, since two branches are leaving the breakaway point, the angles at breakaway are ±90°. This completes the sketch of the root locus 78 as shown in FIG. 6C.

The root locus 78 (FIG. 6C) begins at the poles P₁=0 and P₂=−1/τ with the gain K being equal to zero. The root locus 78 (FIG. 6C) then travels along the negative segment of the real axis 74 (FIG. 6C) while the value of K is incremented and converges at the breakaway point at s=−½τ. At the breakaway point the root locus 78 (FIG. 6C) branches, parallel to the imaginary axis 76 (FIG. 6C), towards the zeros at infinity with the gain K being further incremented until it reaches infinity.

It will be appreciated that the root locus 78 (FIG. 6C) represents all values of s in the Laplace domain for which the characteristic equation (18) is satisfied as the gain K is varied from zero to infinity. From the root locus diagram 72 (FIG. 6C) it may be observed that all of the roots (except the root at the pole P₁=0) lie on the left side of the imaginary axis 76 in the s-plane. This indicates that the system is unconditionally stable for all possible values of the gain K>0 and the system is limitedly stable when the gain K=0. Thus, the control system representation 42 (FIG. 6C) of the aspirate-dispense system 10 (FIG. 1) demonstrates stability for all values of K. This concurs with the above stability analysis based on the solution for the roots of the characteristic equation (18) or (20).

It was demonstrated above that providing a positive displacement pump 22 in series with a dispenser 12 (FIG. 1) has the benefit of forcing the dispenser 12 to admit and eject a quantity and/or flow rate of reagent as determined solely by the positive displacement pump 22 for steady state operation. In essence, the syringe pump 22 acts as a forcing function for the entire system, ensuring that the desired flow rate is maintained regardless of the duty cycle, frequency or other operating parameters of the dispensing valve, such as the solenoid-actuated valve 20 (FIG. 3). With such configuration and at steady state operation one does not really care what the pressure in the system is because it adjusts automatically to provide the desired flow rate by virtue of having a positive displacement or direct current fluid source as a forcing function for the entire system.

However, this does not address the situation of latent and/or transient pressure variations, such as associated with initial start-up of each dispense and aspirate function. In particular, it has been discovered that the pressure in the system is of critical concern for non-steady state operation involving aspirating or dispensing of microfluidic quantities of reagent or other fluids. Specifically, for an aspirate function it has been discovered that a system pressure close to or below zero is most preferred, while for a dispense function it has been discovered that a finite and positive predetermined steady state pressure is most preferred. The transitions between various modes (aspirate, dispense, purge/wash) and/or flow rates or other operating parameters can result in pressure transients and/or undesirable latent pressure conditions within the aspirate-dispense system 10 (FIG. 1). Purge and wash functions usually entail active dispensing in a non-target position. In some cases, when the same reagent is to be aspirated again, several aspirate-dispense cycles can be performed before executing a purge or wash function. Also, sometimes a purge function may have to be performed during a dispense function, for example, to alleviate clogging due to the precipitation of gaseous bubbles within the system and/or source fluid.

Consider the scenario when an aspirate function is performed right after the termination of a dispense function. For the positive displacement system 10 (FIG. 1), aspiration generally involves operating the syringe pump 22 (FIG. 1) in the reverse direction while maintaining the drop-on-demand 20 valve (FIG. 3) open to suck reagent from the fluid source 29 (FIG. 1) through the nozzle 38 (FIG. 3). But, it was discovered that immediately after a dispense function the aspirate-dispense system 10 (FIG. 1) maintains a residual positive pressure due to the above-described capacitance effect. As a result, and disadvantageously, when the drop-on-demand valve 20 (FIG. 3) is opened to initiate aspiration, the positive hydraulic pressure within the aspirate-dispense system 10 (FIG. 1) forces a small amount of pre-aspirated and/or system fluid to be ejected from the nozzle 38 (FIG. 3) and into the fluid source (FIG. 1). Undesirably, this can cause dilution, and possibly contamination, of the fluid or reagent in the source container 29 (FIG. 1). Eventually, as the syringe pump 22 (FIG. 1) is decremented the system pressure is relieved and approaches zero and then goes below zero to create a partial vacuum in the aspirate-dispense system 10 (FIG. 1) for sucking in reagent. But, due to the time lag in reaching the desired aspirating pressure the displacement of the syringe pump 22 (FIG. 1) may not correspond to the actual volume of reagent aspirated, and hence an inaccurate volume of reagent may be aspirated. This pressure transient may not be a problem for aspirating and dispensing relatively large quantities of fluid, but it can be a significant problem for microfluidic applications where low volumes, for example, less than 1 microliters (μL), of reagent are aspirated and dispensed because none or very little of the source reagent may be retrieved.

Similarly, consider the scenario when a dispense function-is performed directly after the termination of an aspirate function. The dispense function generally involves operating the syringe pump 22 (FIG. 1) in the forward direction while opening/closing the drop-on-demand valve 20 (FIG. 3) at a given frequency and/or duty cycle to eject droplets from the nozzle 38 (FIG. 3). But at the termination of an aspirate function, it has been discovered that a residual reduced or negative hydraulic pressure remains within the aspirate-dispense system 10 (FIG. 1), again due to the above-described capacitance effect. Disadvantageously, dispensing is thus initiated with the system pressure being slightly negative or close to zero. This typically is substantially below the desired dispensing pressure for steady state operation. As a result, and undesirably, the initial droplet(s) ejected onto the target will be smaller than the desired size or they may not form at all. If the dispense cycle is long, the system pressure will eventually increase from its near zero value and approach the steady state dispensing pressure. But, in the meantime, inaccurate volumes of reagent will be dispensed until the initial pressure transient dissipates. In some cases, this pressure transient may span most or all of the dispense cycle, especially if only a single or a few microfluidic droplet(s) are to be dispensed. This results in inaccurate and unreliable dispensing.

One way to compensate for those inaccuracies is to perform a “pre-dispense” function before the dispensing of fluid or reagent to allow the system pressure to adjust to the steady state value. This pre-dispense function typically involves a high speed purge of fluid into a waste receptacle (not shown) by operating the syringe pump 22 (FIG. 1) in the forward direction. In some cases, usually when the system is being used purely for dispensing and typically following a high speed bubble purge, the pre-dispense function may be used to reduce the system pressure from a high value to the desired dispensing pressure conditions.

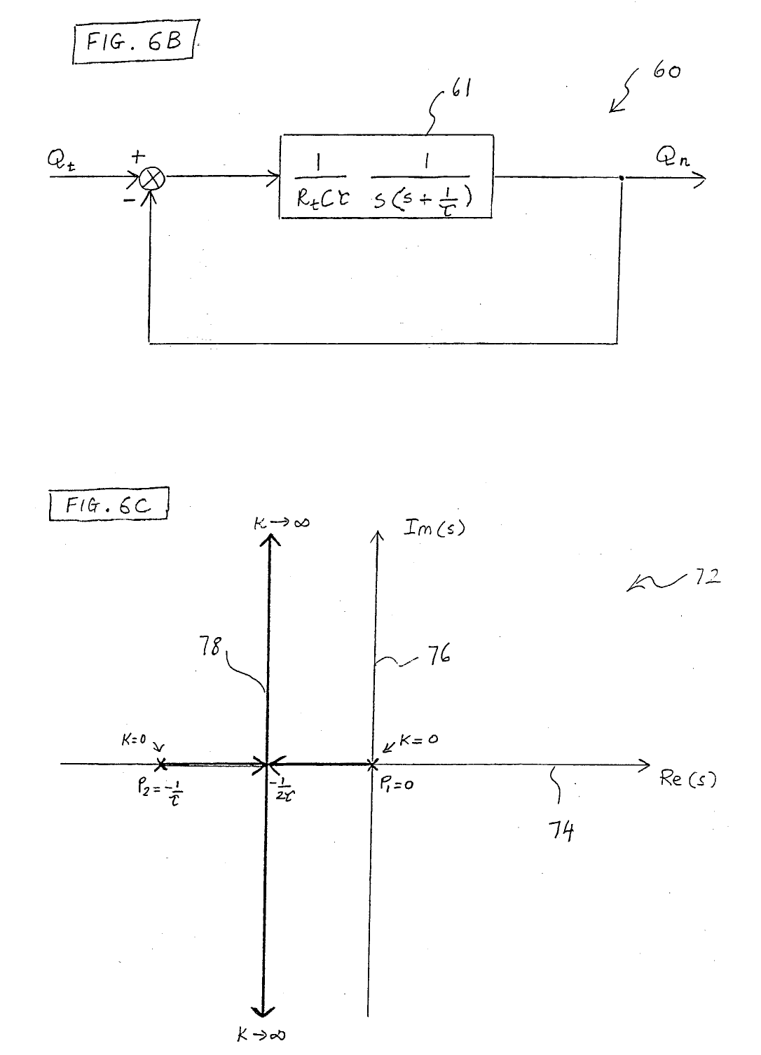

FIG. 7A illustrates the pressure-time history (not to scale) during an aspirate-dispense cycle which employs a “pre-dispense” operation to adjust system pressure. Referring to the schematic graph (not to scale) of FIG. 7A, the x-axis 110 represents the time and the y-axis 112 represents the system pressure. Line 114 depicts the predetermined and/or steady-state pressure during which dispensing occurs, line 116 depicts the pressure change during the aspirate function and line 118 depicts the pressure transient during the pre-dispense operation.

Referring to FIG. 7A, and as indicated before, since the system is pressurized (line 114) prior to the aspirate function (line 116), initial attempts to aspirate source fluid or reagent result in unwanted dispensing of system and/or aspirated fluid into the source 29 (FIG. 1), thereby diluting and potentially contaminating the source fluid. Moreover, the pre-dispense period (line 118) can waste substantial quantities of source reagent and slow down the aspirate-dispense cycle. This can be particularly critical for certain applications, such as DNA microarraying, wherein valuable reagents are utilized and high process speed is desirable. The pre-dispense function also involves maneuvering of the aspirate-dispense system 10 (FIG. 1) and/or a waste receptacle (not shown) to allow accumulation of wasted reagent. This can further reduce the speed and efficiency of the system.

A high speed pre-dispense function can also cause reagent dilution, due to parabolic flow mixing, of the aspirated reagent by the system fluid (distilled water). This reagent dilution may be further enhanced by diffusion, generally a slower process, during the time delay between the aspirate and dispense functions, which permits more opportunity for diffusive processes to contribute to unwanted fluid mixing.

The pre-dispense function also leads to potentially unsatisfactory operational constraints. The residual pressure prior to aspiration can dictate a minimum aspiration volume, based on syringe pump displacement, of at least 1 μL just to initiate entry of reagent into the system. Once reagent is aspirated into the system, the pre-dispense process not only consumes aspirated reagent by wasteful dispensing, but also causes dilution, due to parabolic flow mixing, of the aspirated sample by the system fluid. As a result, a large volume of excess reagent is required to be aspirated in order to mitigate these effects and to assure that reagent volumes are dispensed at full reagent concentration. For example, the lower limit on aspiration volume can be as high as approximately 5 μL in order to dispense only 100 nL of reagent at full concentration.

Optimized Aspirate-Dispense Operation

The above discussion highlights the desirability of controlling the hydraulic pressure within a microfluidic aspirate-dispense system. In one preferred embodiment the method of the present invention causes a steady state pressure to exist within a liquid delivery system, such as the positive-displacement aspirate-dispense system 10 (FIG. 1), prior to initiating dispensing operations. The initial positive pressure overcomes the system's elastic compliance and thereby achieves a steady state pressure condition prior to dispensing. Advantageously, this assures that the fluid displaced by the syringe pump 22 (FIG. 1) will be completely transferred as output to the system nozzle, such as the nozzle 38 (FIG. 3).

One preferred method of the present invention facilitates the aspirate-dispense process by providing an efficient pressure compensation scheme which is efficient in both fluid or reagent consumption and time. To illustrate this method, reference will be made to the aspirate-dispense system 10 (FIG. 1), the syringe pump 22 (FIGS. 1 and 2) and the solenoid-actuated dispenser 12 (FIG. 3), though other liquid delivery systems, direct current fluid sources and dispensers may be utilized with efficacy, as required or desired, giving due consideration to the goal of providing an efficient pressure compensation scheme for aspirate and/or dispense functions.

FIG. 7B shows a schematic graph (not to scale) illustrating the pressure-time history for a pressure compensated aspirate-dispense cycle in accordance with one preferred method of the present invention. The x-axis 120 represents the time and the y-axis 122 represents the system pressure. Line 124 depicts the predetermined and/or steady state pressure during which dispensing occurs, line 126 depicts the pressure compensation prior to the aspirate function, line 128 depicts the pressure during the aspirate function, and line 130 depicts the pressure compensation prior to the dispense function.

As indicated before, just preceding an aspirate function a system pressure close to or below zero is preferred. Referring to FIG. 7B, this is achieved by first “venting” the system (line 126) to release the pressure. This may be done in a variety of ways, such as performing a series of rapid waste dispenses. For example, the nozzle 38 (FIG. 3) may be positioned over a waste receptacle (not shown) and the drop-on-demand valve 20 (FIG. 3) opened and closed rapidly without operating the syringe pump 22 (FIGS. 1 and 2). The opening of the valve 20 causes some system fluid 14 (FIG. 1) and/or any residual aspirated source fluid-from the prior aspirate function to be dispensed into the waste position due to the dispense steady state pressure (line 124) or any residual pressure within the system 10 (FIG. 1). After several valve openings the residual pressure (line 124) dissipates and the system pressure stabilizes to a value near zero. Desirably, this “venting” of system pressure can concurrently serve as a wash function.

Alternatively, the valve 20 (FIG. 3) may remain closed while the syringe pump 22 (FIGS. 1 and 2) is operated in the reverse direction, as required to release system pressure. The residual pressure may also be released by providing a separate relief valve (not shown) for the syringe pump 22 (FIG. 1) or the shut-off valve 25 (FIG. 1) can be opened to release system fluid 14 (FIG. 1) back into the reservoir 16 (FIG. 1).

Advantageously, and referring to FIG. 7B, at this point the source fluid from the source 29 (FIG. 1) can be aspirated (line 128) without the spurious dispense or ejection of system fluid 14 (FIG. 1) and/or residual aspirated fluid into the source 29 (FIG. 1). The nozzle 38 (FIG. 3) is placed in the source 29 (FIG. 1) and, with the valve 20 (FIG. 3) open, the syringe pump 22 (FIGS. 1 and 2) is operated in the reverse direction, creating a reduced or negative pressure (line 128), to aspirate source fluid or reagent into the tip 36 (FIG. 3) of the aspirate-dispense system 10 (FIG. 1). Preferably, the valve 20 (FIG. 3) is open continuously during aspiration, that is, a 100% duty cycle is utilized. Advantageously, since the system pressure is at or close to zero, predetermined small volumes of source fluid can be substantially accurately aspirated by metering the displacement of the syringe pump 22 (FIGS. 1 and 2). Also, by preferably utilizing an optimally slow motion of the syringe pump plunger 64 (FIG. 2) while having the valve 20 (FIG. 3) fully open, the reduced/negative aspirate system pressure is kept close to zero so that the flow of source fluid into the nozzle 38 (FIG. 3) and tip 36 (FIG. 3) is maintained generally laminar. The displacement rate of the syringe pump plunger 64 (FIG. 2) is dependent on the volume to be aspirated, but it is typically in the range of about 0.5 to 50 μL/sec. For aspiration of very small volumes the plunger displacement rate is about 0.5 μL/sec. Moreover, utilizing a 100% valve duty cycle, during aspiration, further assists in maintaining a generally laminar flow of source fluid into the nozzle 38 (FIG. 3) and tip 36 (FIG. 3). Thus, turbulent mixing of source fluid with system fluid 14 (FIG. 1) is minimized, and any dilution of the source fluid will essentially be due to diffusion. Advantageously, in most cases, at or near room temperature, the diffusion process is very slow, and hence the overall effective dilution of the source fluid or reagent is small or negligible, as will be supported by experimental data presented later herein.

As outlined earlier, and as can be seen by line 128 in FIG. 7B, the aspiration process (line 128) results in a partial vacuum or residual reduced/negative pressure within the aspirate-dispense 10 (FIG. 1), which is less than the preferred dispense steady state pressure (line 124). For effective and accurate dispensing of aspirated fluid the system pressure is preferably raised from the reduced or negative value to a positive dispense steady state and/or predetermined value. A simple, fast technique to raise the system pressure to the preferred dispense pressure is by displacing the syringe pump plunger 64 (FIG. 2) in the forward direction while keeping the drop-on-demand valve 20 (FIG. 3) in the closed position. This preferred “pressurizing” pressure compensation is illustrated by line 130 (FIG. 7B).

Once the system pressure has been raised to the nominal steady state dispense pressure (line 124), the predetermined quantity or quantities of aspirated source fluid can be accurately dispensed. During dispensing the displacement of the syringe pump plunger 64 (FIG. 2) can be synchronized with the duty cycle of the drop-on-demand valve 20 (FIG. 3) or, alternatively, the pump 22 (FIG. 1) can be used to supply a generally continuous flow rate. Advantageously, such a pressurization scheme is efficient, does not waste reagent and reduces reagent dilution.

In one embodiment, the above pressurization scheme can also be followed by a pre-dispense operation for fine tuning of the system pressure to the desired steady state and/or predetermined value. This pre-dispense typically involves dispensing a small quantity of fluid back into the aspiration fluid source. The pre-dispense may also be performed by dispensing in a waste position. Advantageously, after the pressurization scheme the system pressure is sufficiently close to the steady-state and/or predetermined value, and hence this pre-dispensing of fluid results in small, negligible or no wastage of fluid.

TABLE 1
COMPARISON OF MEASURED AND THEORETICAL DISPENSE VOLUMES

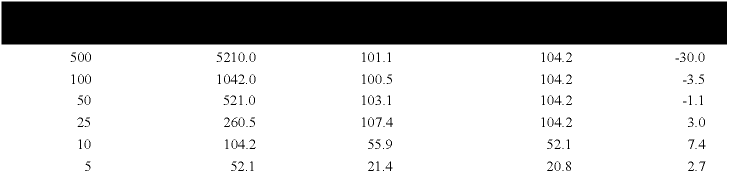

Table 1 illustrates the feasibility and accuracy of the method of the present invention by comparing experimental data (measured dispense volumes achieved by the method of the present invention) with the ideal or theoretical dispense volumes. As can be seen from Table 1 the error in dispensed volume is small (less than 8%) in all cases. Moreover, and very importantly, about 100 nL of fluid or reagent can be reliably dispensed at full concentration from a sample aspiration volume of only about 250 nL. Also, as shown in Table 1, lower dispensed volumes can be achieved from aspiration volumes less than 250 nL. For example, about 20 nL can be reliably dispensed at full concentration from an aspirated volume of only about 50 nL.

The volume measurements of Table 1 are based on a calibration curve of measured absorbance of a dye, such as tartrazine, at a wavelength of 450 nm using a standard microtiter plate reader. The calibration curve is established based on absorbance values for known volumes of dye. The curve allows for the determination of dispense volume based on the measured absorbance, as is well known in the art. For the data presented in Table 1, tartrazine dye was dissolved in DSMO. The “venting” procedure (line 126 in FIG. 7B) prior to aspiration involved twenty system fluid dispenses at 20 Hz with a 30% on-time. The “pressurizing” procedure (line 130 in FIG. 7B) involved displacing the syringe pump plunger 64 (FIG. 2) the required number of steps while keeping the drop-on-demand valve 20 (FIG. 3) closed.

The accuracy of the data of Table 1 indicates that the diffusion process is to first order negligible in the dilution of source fluid by system fluid, such as distilled water. If diffusion induced dilution was a major factor in the method of the present invention, it would be difficult to provide reliable dispensing of small aspirated volumes, as shown by the data of in Table 1. The results of Table 1 further indicate that generally laminar flow is maintained during aspirate and dispense functions which desirably eliminates or reduces turbulence induced mixing of source and system fluids. The existence of the desired laminar flow is further corroborated by experimental evidence, wherein a series of 100 nL dispenses can be performed from an aspirated fluid volume of 10 μL where about 60-70% of the aspirated source fluid is recoverable without significant dilution, and about 90% of the aspirated fluid is recoverable at an acceptable concentration level.

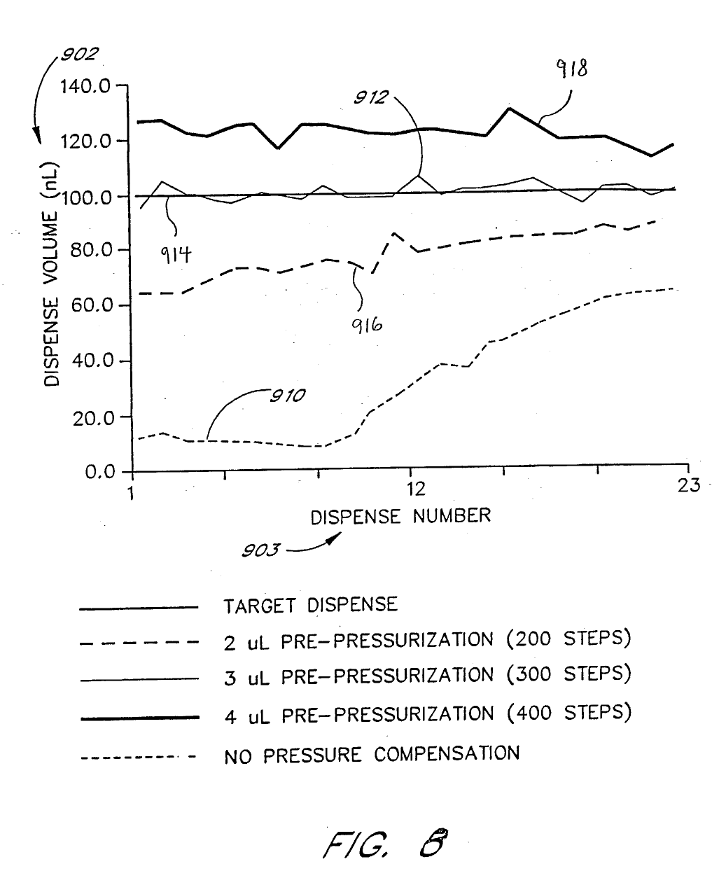

Referring to FIG. 9, the above experimental data also indicate that the expected bullet-shaped fluid velocity profile 44 (maximum velocity along centerline and decreasing to zero at the side walls) of aspirated fluid in the nozzle 38 and/or tip 36 during aspiration is desirably reversible during dispensing (dispensed fluid velocity profile 46 in FIG. 9), as would be predicted by laminar flow theory. The idealized schematic of FIG. 9, suggests that the net effect of the laminar aspirate and dispense velocity profiles 44, 46 results in quiescent aspirated fluid (line 48) and/or negligible residual aspirated fluid (line 48) after the conclusion of an aspirate-dispense cycle.

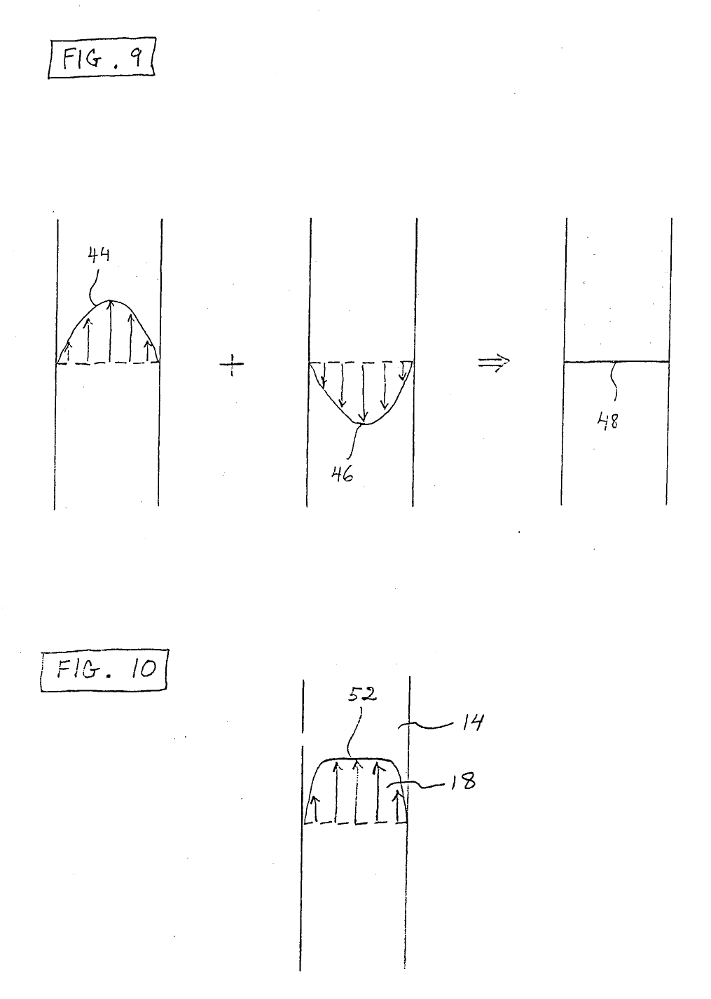

Optionally, the internal surface(s) of the nozzle 38 (FIG. 3) and/or the tip 36 (FIG. 3) may be coated with a hydrophobic coating, such as teflon, paraffin, fat or a silanized coating among others. This can assist in further reducing the dilution of aspirated source fluid by system fluid 14 (FIG. 1). The hydrophobic coating enhances the flow of source fluid or reagent at the boundary layer between the fluid and the inner walls of the nozzle 38 and/or tip 36 (FIG. 3). This transforms the typical laminar flow bullet shaped velocity profile 44 (FIG. 9) of aspirated reagent into a desirably more blunt velocity profile 52. (FIG. 10). Advantageously, the blunt velocity profile 52 (FIG. 10) results in a reduced contacting surface area at the boundary between the system fluid 14 (FIG. 10) and the aspirated source fluid or reagent 18 (FIG. 10) which further minimizes the diffusive mixing between the source and system fluids.

Optionally, the hydrophobic coating, such as teflon, paraffin, fat or a silanized coating among others, can also be applied to a portion of the outer surface(s) of the nozzle 38 (FIG. 3), as desired. This hydrophobic coating advantageously reduces the adherence of fluid on the outer surface of the nozzle 38 (FIG. 3) during aspiration and wash cycles. This can be particularly important for the first dispense of reagent made immediately after aspiration, since some of the source fluid may otherwise stick to the outer surface of the nozzle 38 (FIG. 3) as it is dipped in the source 29 (FIG. 1) during aspiration and be dispensed with the first dispense, thereby creating an error in the first dispense volume. The hydrophobic coating on the outer surface of the nozzle 38 (FIG. 3) reduces the possibility of this undesirable dispense error.

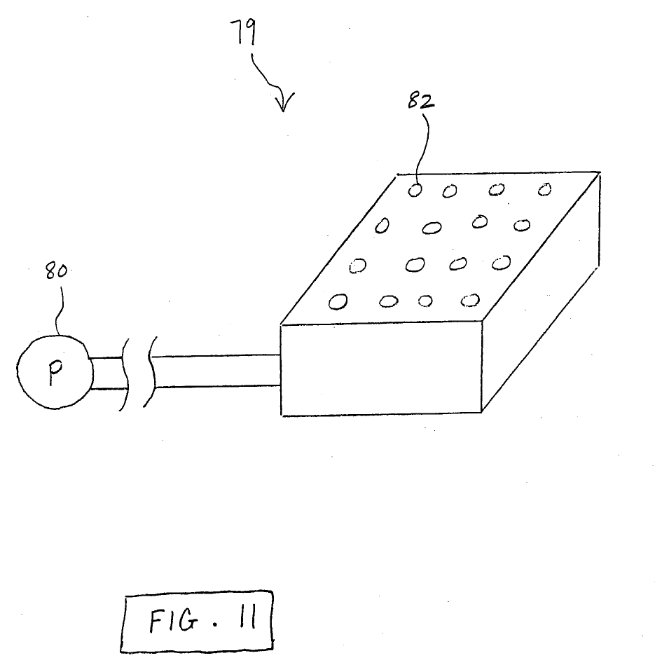

In one embodiment, after aspiration and prior to dispensing, a vacuum dry may be used to remove any excess fluid that may have adhered to the outer surface of the nozzle 38 and/or tip 36 (FIG. 3) during aspiration of source fluid. FIG. 11 schematically illustrates a system 79 for performing such a vacuum dry. The system 79 generally includes a pump 80 connected to one or more vacuum apertures 82. After aspiration, the nozzle 38 and/or tip 36 (FIG. 3) is inserted into a vacuum aperture 82 (FIG. 11). The pump 80 (FIG. 11) is activated for a predetermined amount of time and provides enough suction to remove or suck any excess fluid sticking to the outer surface of the nozzle 38 and/or tip 36 (FIG. 3) without disturbing the aspirated fluid.

In general, the pressure compensation methods of the present invention may be employed whenever transient pressure variations occur in the aspirate and/or dispense hydraulic system, giving due consideration to achieving the goal of providing predetermined and/or steady state pressures. These pressure transients may occur due to hydraulic “capacitance effect”, leakage or the precipitation of small gaseous bubbles, or during initial start-up or intermittent dispensing operations.

Estimation of Steady State Pressure

The importance of performing aspirate and dispense functions at the optimal pressures has been illuminated so far. The amount of pre-pressurization needed to achieve steady state operation may be determined empirically for a given set-up. An experimental parametric analysis may be performed for a given set-up and several correlations can be obtained. This open-loop control technique will assist in determining the actuations of the syringe pump 22 (FIG. 1) to achieve the optimal operating pressure.

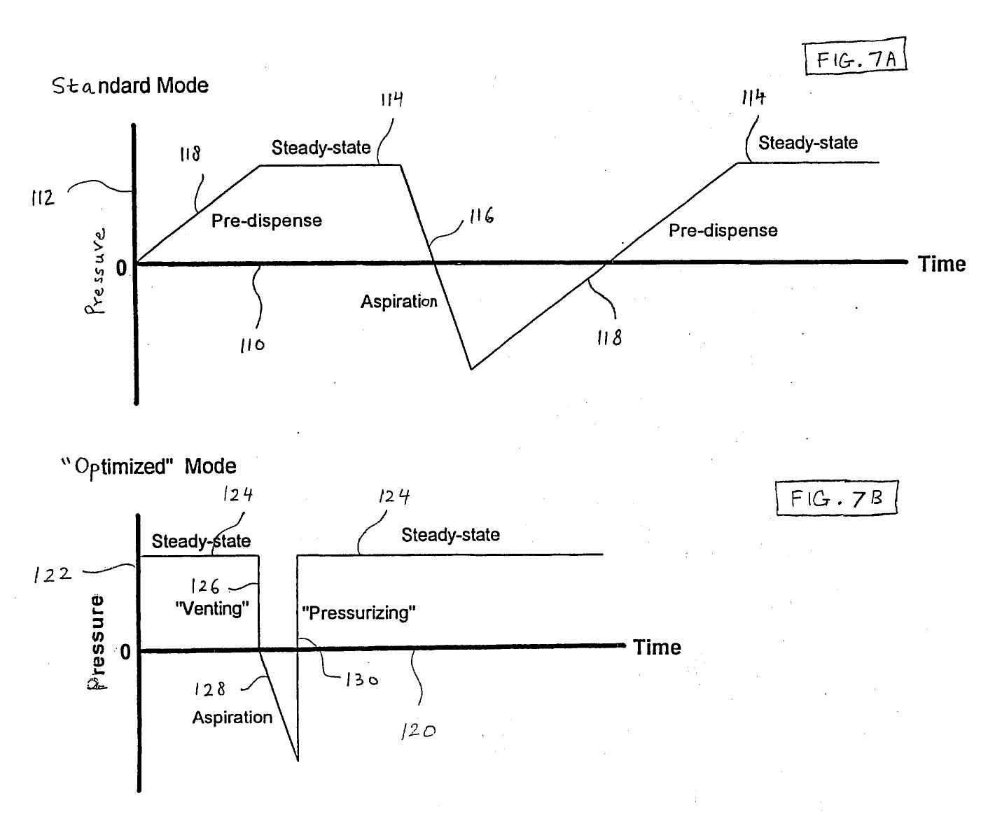

For example, line 910 in FIG. 8 illustrates transient dispense effects caused by initial start-up of a dispensing system 10 (FIG. 1) in which no pressure compensation scheme is utilized. The x-axis 903 represents the dispense number or number of dispenses and the y-axis 902 represents the dispense volume, in nanoliters (nL) of each droplet or droplets dispensed. Line 914 in FIG. 8 represents the target dispense volume of 100 nL.

As can be seen by the data of FIG. 8, the non-pressure compensated (non-steady state) dispensed volume represented by line 910 is substantially smaller than the target dispense volume of 100 nL (line 914) since the system pressure at start-up is substantially lower than the desired steady state and/or predetermined pressure. The non-pressure compensated dispense volume (line 910) can be lower by a factor of about ten compared to the target dispense volume (line 914). Moreover, even after 23 dispenses (see FIG. 8) the dispensed volume (line 910) is still below the target volume (line 914).

Line 912 represents a series of about 100 nL dispenses performed in accordance with one preferred method of the present invention, wherein an empirically-determined optimized pressurizing (300 steps of the syringe plunger 64) is performed prior to dispensing. The pressure compensation scheme provides dispense volumes (line 912) which are in substantially close conformity with the target dispense volume (line 914) of 100 nL. Under-pressurization (200 steps of the syringe plunger 64) can result in dispense volumes that are undesirably less than the target dispense volume 914. Similarly, as illustrated by line 918, over-pressurization (400 steps of the plunger 64) can result in dispense volumes that are undesirably more than the target dispense volume 914.

Another preferred approach of estimating the steady state pressure dispense pressure and the system elastic compliance utilizes a semi-empirical methodology. In this case, one or more pressure sensors 50 (FIGS. 1 and 3) may be included to monitor the system pressure. The pressure measurements as provided by one or more pressure sensors 50 (FIGS. 1 and 3) can also be used to provide diagnostic information about various fluid and flow parameters of the hydraulic system. The pressure sensors 50 can be placed at the drop-on-demand valve 20 (FIG. 3) and/or at appropriate positions intermediate the syringe pump 22 (FIG. 1) and the dispenser 12 (FIG. 1), such as on the feedline 23, as illustrated in FIG. 1. Of course, the pressure sensors 50 may also be placed at other suitable locations, such as at the tip 36 (FIG. 3) or nozzle 38 (FIG. 3), as required or desired, giving due consideration to the goals of providing pressure compensation. Suitable pressure sensors 50 are well known by those of ordinary skill in the art and, accordingly, are not described in greater detail herein. The semi-empirical approach utilizes fluid flow theory and measurements from one or more pressure sensors 50 (FIGS. 1 and 3) positioned at suitable locations.

As indicated above, the preferred pre-dispense pressure compensation involves displacing the syringe pump plunger 64 (FIG. 2) while maintaining the valve 20 (FIG. 3) in a closed position. The amount of plunger displacement can be estimated by calculating the elastic compliance and the steady state pressure. The steady state pressure, typically between 2000 to 6000 Pascals (Pa), can be estimated, as discussed below, from flow resistance and/or prior steady state or transient pressure measurements. The elastic capacitance, C, can be estimated from:

$$C = \frac{Δ V}{Δ P} \qquad ( 25 )$$

where, ΔV is the change in volume as determined by the displacement of the syringe pump plunger 64 (FIG. 2) and ΔP is the change in pressure as measured by the pressure sensor(s) 50 (FIGS. 1 and 3), with the valve 20 (FIG. 3) closed. Thus, the volume displacement, ΔVₛₛ, of the syringe pump plunger 64 (FIG. 2) required to achieve steady state pressure conditions, Pₛₛ, can be estimated by using:

ΔVₛₛ=C(P−Pₛₛ) (26)

where, P in equation (26) is the instantaneous pressure as measured by the pressure sensor(s) 50 (FIGS. 1 and 3). By constantly or periodically monitoring the pressure, P, as the syringe pump plunger 64 (FIG. 2) is moved a continuous or periodic and updated measurement of the elastic compliance, C, can be iteratively used in equation (26) until the pressure converges to the steady state value.

If pressure compensation prior to an aspirate function is provided by displacing the plunger 64 (FIG. 2) to reduce the system pressure with the valve 20 (FIG. 3) in the closed position, equation (26) can be similarly used to estimate the plunger displacement. In this case, and as discussed before, the desired aspirating pressure will typically be slightly negative or close to zero.

As indicated above, the steady state pressure, typically between 2000 to 6000 Pascals (Pa), can be estimated from flow resistance and/or prior steady state or transient pressure measurements. An estimate of the steady state pressure can be made by calculating the nozzle pressure or pressure drop based on a theoretical computation of the nozzle capillary flow resistance (R_{c}) and the nozzle orifice flow resistance (Rₒ) by using the following:

$$\begin{matrix}{R}_{c} = \frac{8 μ L\_nom}{{π ( \frac{D\_nom}{2} )}^{4}} & ( 27 ) \\ {R}_{o} = \frac{\sqrt{\frac{ρ}{2}}}{{C}_{d} {π [ \frac{D\_nom}{2} ]}^{2}} & ( 28 )\end{matrix}$$

where, ρ is the fluid density, μ is the fluid viscosity, L_nom is the nominal nozzle length, D_nom is the nominal nozzle diameter, and C_{d} is the discharge coefficient. The nozzle pressure drop or total input pressure, Psᵢₙ, can be calculated from the following:

Ps_{cap}=QR_{c} (29)

Ps_{orf}=(QRₒ)² (30)

Psᵢₙ=Ps_{cap}+Ps_{orf} (31)

where, Ps_{cap} is the pressure drop due to the nozzle capillary resistance, Ps_{orf} is the pressure drop due to the nozzle orifice flow resistance and Q is the flow rate as provided by the syringe pump 22 (FIG. 1) during dispensing.

Psᵢₙ, the nozzle pressure drop, is an estimate of the desired dispensing steady state pressure within the aspirate-dispense system 10 (FIG. 1). This is because preferably the bulk of the pressure drop through the aspirate-dispense system 10 (FIG. 1) is across the nozzle 38 (FIG. 3).

An estimate of the steady state pressure can also be obtained by estimating the nozzle capillary and orifice flow resistances by utilizing pressure measurements from the sensor(s) 50 (FIGS. 1 and 3) during dispensing. The capillary flow resistance and the orifice flow resistance can be estimated by making two measurements of the system pressure at two flow rates during steady state dispensing from the following:

$$\begin{matrix}R c\_est = \frac{{P}_{l} {Q}_{h}^{2} - {P}_{h} {Q}_{l}^{2}}{{Q}_{h} {Q}_{l} ( {Q}_{h} - {Q}_{l} )} & ( 32 ) \\ R o\_est = \sqrt{\frac{{P}_{h} {Q}_{l} - {P}_{l} {Q}_{h}}{{Q}_{h} {Q}_{l} ( {Q}_{h} - {Q}_{l} )}} & ( 33 )\end{matrix}$$

where, Qₗ is the low flow rate, Qₕ is the high flow rate, Pₗ is the pressure measurement at Qₗ, Pₕ is the pressure measurement at Qₕ, Rc_est is the estimate of the capillary flow resistance and Ro_est is the estimate of the orifice flow resistance. The two pressure measurements, Pₗ and Pₕ, can be made during steady state on-line dispensing by modulating the flow rate about the operating point by a small amount, for example, about ±5%. Optionally, a calibration mode can be used off-line to make the pressure measurements. Once estimates of the capillary flow resistance, Rc_est, and the orifice flow resistance, Ro_est, have been determined, these can be used in conjunction with equations (29), (30) and (31) to obtain an estimate of the nozzle pressure drop, Psᵢₙ, which can be estimated as a steady state pressure.

Advantageously, the above semi-empirical estimates of the capillary flow resistance, Rc_est, and the orifice flow resistance, Ro_est, permit the density and viscosity of the fluid to be estimated by using:

$$\begin{matrix}µ\_est = \frac{π R {c\_est [ \frac{D\_nom}{2} ]}^{4}}{8 L\_nom} & ( 34 ) \\ ρ\_est = {2 [ π {C}_{d} \frac{{D\_nom}^{2}}{4} R o\_est ]}^{2} & ( 35 )\end{matrix}$$

where, ρ_est is the estimated fluid density and μ_est is the estimated fluid viscosity.

In the case that an initial pressure transient is encountered prior to steady state dispensing, transient pressure measurements utilizing the pressure sensor(s) 50 (FIGS. 1 and 3) can be used to estimate the nozzle capillary and orifice flow resistances. This approach is generally accurate only when the initial pressure is within 30-50% of the steady state value because a linearized approximation of the differential equations is used. The linearized pressure equations for an initial pressure of Pᵢ at the time that pulsed dispensing operation begins and decays to the steady state value of Pₛₛ can be approximated by:

$$\begin{matrix}P ( t ) = {P}_{ss} + ( {P}_{l} - {P}_{ss} ) {ⅇ}^{- \frac{t}{α} ( {F}_{valve} {T}_{v} )} & ( 36 ) \\ α = C [ {R}_{c} + \frac{2 {R}_{o}^{2} {Q}_{step}}{{F}_{valve} {T}_{v}} ] & ( 37 ) \\ {P}_{ss} = {R}_{o}^{2} {Q}_{nozzle}^{2} + {R}_{c} {Q}_{nozzle} & ( 38 ) \\ {Q}_{nozzle} = \frac{{Q}_{step}}{{F}_{valve} {T}_{v}} & ( 39 )\end{matrix}$$

where, P(t) is the instantaneous pressure as a function of time t, α is the system time constant, Fᵥₐₗᵥₑ is the open-close frequency of the drop-on-demand-valve 20 (FIG. 3), Tᵥ is the valve open time/valve pulse width of the drop-on-demand-valve 20 (FIG. 3), C is the elastic capacitance, Qₛₜₑₚ is the instantaneous flow rate as provided by the syringe pump 22 (FIG. 1) which is operated by the stepper motor 26 (FIG. 1), and Q_{nozzle} is the instantaneous flow rate through the nozzle 38 (FIG. 3). The elastic capacitance, C, can be estimated from pressure and volume changes with the valve 20 (FIG. 3) closed, as is discussed above. Note that (FᵥₐₗᵥₑTᵥ) is a scaling factor since the drop-on-demand valve 20 (FIG. 3) is not open all the time in pulsed operation. If the valve 20 is open continuously, this scaling factor reverts to 1 since the instantaneous nozzle flow rate, Q_{nozzle}, and the stepper flow rate, Qₛₜₑₚ, are the same.

The above equations (36) to (39) can be manipulated to give:

$$\begin{matrix}α = \frac{{t}_{1}}{ln ( \vert {P}_{i} - {P}_{ss} \vert ) - ln ( \vert {P}_{l} - {P}_{ss} \vert )} {F}_{valve} {T}_{v} & ( 40 ) \\ R c\_est = \frac{{F}_{valve}}{{Q}_{step}} [ 2 {P}_{ss} {T}_{v} - \frac{{Q}_{step} α}{{F}_{valve} C} ] & ( 41 ) \\ R o\_est = \frac{{F}_{valve}}{{Q}_{step}} \sqrt{[ \frac{{Q}_{step} α}{C {F}_{valve}} - {P}_{ss} {T}_{v} ] {T}_{v}} & ( 42 )\end{matrix}$$

where, Pᵢ is the measured initial pressure prior to dispensing, Pₛₛ is the measured steady state pressure after a substantially long time, and Pₗ is the measured pressure during decay at time tₗ. These pressures can be measured using the pressure sensor(s) 50 (FIGS. 1 and 3). The pressure Pₗ can be measured at several different times and the results averaged to reduce noise. In this manner estimates of the nozzle capillary flow resistance, Rc_est, and nozzle orifice flow resistance, Ro_est, can be obtained. These estimates of the capillary flow resistance, Rc_est, and the orifice flow resistance, Ro_est, can be used in conjunction with equations (29), (30) and (31) to obtain an estimate of the nozzle pressure drop, Psᵢₙ, which can be estimated as a steady state pressure.

The apparatus or system 10 (FIG. 1) may be used for a wide variety of modes such as dot dispensing, continuous dispensing and printing of micro-arrays, among other applications. The operation of the aspirate-dispense system 10 (FIG. 1) may be monitored and controlled by a suitable automated control system. Additionally, the control system may be interfaced with any robot arms and/or X, X-Y or X-Y-Z movable platforms used in conjunction with the aspirate-dispense system 10, source 29, target 30 and waste receptacle to facilitate maneuverability of the various components of the system and its associated elements.

Those skilled in the art will readily recognize the benefits and advantages of the present invention, especially as applied to high frequency transitions between aspirating and dispensing of microfluidic quantities of reagents. These benefits and advantages are at least partially accomplished by providing an efficient pressure compensation scheme to realize the optimal pressures for efficient, accurate and reliable aspirating and/or dispensing. The optimal pressures are achieved by a series of optimized operations which maximize process speed, minimize dilution effects and minimize wastage of valuable reagent.

While the methods and systems of the present invention have been described with a certain degree of particularity, it is manifest that many changes may be made in the specific designs, constructions and methodology hereinabove described without departing from the spirit and scope of this disclosure. It should be understood that the invention is not limited to the embodiments set forth herein for purposes of exemplification, but is to be defined only by a fair reading of the appended claims, including the full range of equivalency to which each element thereof is entitled.

What is claimed is:

1. A method for aspirating a fluid from a source using an aspirate-dispense system including a drop-on-demand valve in fluid communication with a direct current fluid source, comprising the steps of:
reducing the hydraulic pressure within said system by opening said valve of said system to dispense system liquid into a non-target position;
dipping a tube of said system in said fluid source; and
creating a reduced pressure in said system to aspirate a quantity of said fluid of said source into said tube of said system.

2. The method of claim 1, wherein said step of creating a reduced pressure includes the step of maintaining a 100% duty cycle for said drop-on-demand valve.

3. The method of claim 1, wherein said step of reducing includes the step of operating said direct current fluid source of said system to substantially release the hydraulic pressure within said system.

4. The method of claim 1, wherein between said steps of reducing and dipping is included the step of providing relative movement between said system and said source so that said tube of said system is substantially aligned with said source.

5. The method of claim 1, wherein said step of creating a reduced pressure includes the step of adjusting said direct current fluid source of said system to draw fluid from said source.

6. The method of claim 1, further including the step of dispensing said fluid onto a target.

7. The method of claim 1, further including the steps of:
providing relative movement between said system and a target so that said tube of said system is substantially aligned with said target;
pressurizing said system by adjusting said direct current fluid source of said system while maintaining said valve in a closed position to build hydraulic pressure within said system to a generally steady state value; and
actuating said direct current fluid source and said valve of said system to dispense precise and/or predetermined quantities of said fluid onto said target.

8. The method of claim 1, further including the step of monitoring the hydraulic pressure within said system by pressure sensing means.

9. A method for aspirating a fluid from a source, comprising the steps of:
reducing the hydraulic pressure within an aspirate-dispense system by withdrawing a predetermined quantity of system fluid from a feedline of said system;
dipping a tube of said system in said fluid source; and
adjusting positive displacement means of said system so that a reduced pressure is created in said system to aspirate a quantity of said fluid of said source into said tube of said system.

10. The method of claim 9, wherein at least a portion of said tube of said system is coated with a hydrophobic material.

11. The method of claim 9, wherein said step of reducing includes the step of opening a valve of said system to dispense system liquid in a non-target position so that the system pressure is reduced.

12. The method of claim 9, wherein said step of reducing includes the step of maintaining a drop-on-demand valve of said system in a closed position.

13. The method of claim 9, wherein between said steps of reducing and dipping is included the step of providing relative movement between said system and said source so that said tube of said system is substantially aligned with said source.

14. The method of claim 9, wherein said step of adjusting includes the step of displacing a plunger of a positive displacement syringe pump by a predetermined amount.

15. The method of claim 9, further including the step of dispensing said fluid onto a target.

16. The method of claim 9, further including the steps of:
providing relative movement between said system and a target so that said tube of said system is substantially aligned with said target;
pressurizing said system by adjusting said positive displacement means while maintaining a valve of said system in a closed position to build hydraulic pressure within said system to a generally steady state value;
actuating said positive displacement means and said valve of said system to dispense precise and/or predetermined quantities of said fluid onto said target.

17. The method of claim 9, further including the step of monitoring the hydraulic pressure within said system by pressure sensing means.

18. A method for dispensing a fluid onto a target using an aspirate-dispense system including a drop-on-demand valve in fluid communication with a direct current fluid source, comprising the steps of:
pressurizing said system by adjusting said direct current fluid source of said system while maintaining said valve of said system in a closed position to build hydraulic pressure within said system to a generally steady state and/or predetermined value;
selecting a desired flow rate of fluid to be dispensed from a tube of said system onto said target; and
operating said direct current fluid source and said valve of said system to dispense precise and/or predetermined quantities of said fluid onto said target.

19. The method of claim 18, wherein between said steps of pressurizing and selecting is included the step of performing a pre-dispense operation by dispensing fluid in a non-target position to fine tune the system pressure.

20. The method of claim 18, wherein said step of pressurizing includes the step of displacing a plunger of a positive displacement syringe pump of said direct current fluid source to increase the system pressure.

21. The method of claim 18, wherein said step of operating includes the step of displacing a plunger of a positive displacement syringe pump of said direct current fluid source by a predetermined amount or series of predetermined amounts.

22. The method of claim 18, wherein before said step of pressurizing is included the step of aspirating said fluid from a source.

23. The method of claim 18, wherein before said step of pressurizing are included the steps of:
venting said system by opening said valve of said system to dispense system wash liquid and/or said fluid into a non-target position so that the hydraulic pressure within said system is reduced;
providing relative movement between said system and a source so that said tube of said system is substantially aligned with said source;
dipping said tube of said system in said fluid source;
adjusting said direct current fluid source of said system so that a reduced pressure is created in said system to aspirate a quantity of said fluid of said source into said tube of said system; and
supplying relative movement between said system and said target so that said tube of said system is substantially aligned with said target.

24. The method of claim 18, further including the step of monitoring the hydraulic pressure within said system by pressure sensing means.

25. A method for aspirating fluid from a source and dispensing said fluid onto a target using an aspirate-dispense system including a drop-on-demand valve in hydraulic communication with a direct current fluid source, comprising the steps of:
adjusting said system by opening said valve of said system to dispense system liquid into a non-target position so that the hydraulic pressure within said system is reduced;
dipping a tube of said system in said fluid source;
creating a reduced pressure in said system by operating said direct current fluid source to aspirate a quantity of said fluid of said source into said tube of said system;
pressurizing said system by adjusting said direct current fluid source of said system while maintaining said valve in a closed position to build hydraulic pressure within said system to a generally steady state value; and
actuating said direct current fluid source and said valve of said system to dispense precise and/or predetermined quantities of said fluid onto said target.

26. The method of claim 25, wherein between said steps of creating a reduced pressure and pressurizing said system is included the step of inserting a portion of said tube in a vacuum aperture to remove any fluid adhering to the outer surface of said tube.

27. The method of claim 25, wherein said step of adjusting said system includes the step of operating said direct current fluid source to reduce the hydraulic pressure within said system.

28. The method of claim 25, wherein between said steps of adjusting and dipping is included the step of providing relative movement between said system and said source so that said tube of said system is substantially aligned with said source.

29. The method of claim 25, wherein said step of creating a reduced pressure includes the step of displacing a plunger of a positive displacement syringe pump of said direct current fluid source by a predetermined amount to aspirate said fluid.

30. The method of claim 25, wherein said step of pressurizing includes the step of displacing a plunger of a positive displacement syringe pump of said direct current fluid source to increase the system pressure.

31. The method of claim 25, wherein said step of actuating includes the step of displacing a plunger of a positive displacement; syringe pump of said direct current fluid source by a predetermined amount or series of predetermined amounts.

32. The method of claim 25, wherein between said steps of creating and pressurizing is included the step of providing relative movement between said system and said target so that said tube of said system is substantially aligned with said target.

33. The method of claim 25, further including the step of monitoring the hydraulic pressure within said system by pressure sensing means.

34. A method for adjusting the hydraulic pressure of an aspirate-dispense system after a purge operation, comprising the step of adjusting said system by venting a drop-on-demand valve of said system to dispense system liquid into a non-target position so that the hydraulic pressure within said system is reduced to a predetermined and/or generally steady state value.

35. The method of claim 34, wherein said step of adjusting includes the step of operating positive displacement means of said system to reduce the hydraulic pressure within said system.

36. An apparatus for aspirating and/or dispensing predetermined quantities of a fluid, comprising:
a dispenser including a drop-on-demand valve adapted to be opened and closed at a predetermined frequency and/or duty cycle;
a direct current fluid source in fluid communication with said dispenser for metering predetermined quantities of said fluid to or from said dispenser;
one or more pressure sensors placed intermediate said dispenser and said direct current fluid source and/or at said dispenser for monitoring the hydraulic pressure within said apparatus;
whereby, actuations of said valve and/or said direct current fluid source provide pressure compensation prior to aspirate and/or dispense functions by reducing or raising the hydraulic pressure within said apparatus to a predetermined and/or generally steady state pressure.

37. The apparatus of claim 36, wherein said valve comprises a solenoid-actuated valve.

38. The apparatus of claim 36, wherein said direct current fluid source comprises a positive displacement syringe pump.

39. A hydraulic system for dispensing precise quantities of a fluid, comprising:
a dispenser including a drop-on-demand valve adapted to be opened and closed at a predetermined frequency and/or duty cycle;
a direct current fluid source in fluid communication with said dispenser for metering predetermined quantities of said fluid to said dispenser;
the output fluid flow rate (Qₙ) of said hydraulic system being substantially in accordance with a transfer function having the form:
$$\frac{{Q}_{n}}{{Q}_{t}} = \frac{\frac{K}{s ( s + \frac{1}{τ} )}}{1 + \frac{K}{s ( s + \frac{1}{τ} )}} = \frac{1}{1 + \frac{1}{K} s ( s + \frac{1}{τ} )}$$
with a characteristic equation given by:
$$1 + \frac{K}{s ( s + \frac{1}{τ} )} = 0$$
and a gain K given by:
$$K = \frac{1}{{R}_{t} C τ}$$
where, Qₜ is the input fluid flow rate provided by said direct current fluid source, Rₜ is the flow resistance, C is the elastic capacitance, τ is the inertial or inductive time constant, and s is the Laplacian variable.
